(19) United States
(12) Patent Application Publication
(10) Pub. No.: US 2002/0103752 A1
(43) Pub. Date: Aug. 1, 2002

(54) E-commerce payment solution

(76) Inventors: Caesar Berger, Calabasas, CA (US); Troy E. Maas, Moorpark, CA (US); Bruce R. Shirey, Agoura Hills, CA (US); Pete G. Suarez, Thousand Oaks, CA (US); Steven Y. Woloshin, Canoga Park, CA (US); Timothy I. Miller, Simi Valley, CA (US); Bennett L. Pumphrey, Newbury Park, CA (US)

Correspondence Address: Edward G. Poplawski, Esq., SIDLEY & AUSTIN, 555 West Fifth Street, Los Angeles, CA, 90013-1010, US

(21) Appl. No.: 09/774,352

(22) Filed: Jan. 30, 2001

(51) Int. Cl. G06F 17/60

(52) U.S. Cl. 705/39; 705/40

(57) ABSTRACT

An e-commerce payment solution that enables individuals and low-volume merchants to conduct e-commerce with established electronic payment vehicles, such as credit cards, without resort to permanent payment processing accounts is disclosed. Providing accounts for such small merchants with merchant-hosting entities that in turn are set up and in communication with a payment gateway entity that controls the processing, in concert with the novel payment processing and settlement architecture disclosed, permits many small merchants to effectively conduct online credit or debit transactions on a per transaction basis with little or no set-up costs.

### FIELD OF THE INVENTION

This invention relates to the field of e-commerce payment solutions, and more particularly to methods for enabling low-volume merchants to conduct e-commerce with established electronic payment vehicles, such as credit cards, without resort to permanent payment processing accounts.

### BACKGROUND OF THE INVENTION

Electronic commerce (“e-commerce”), defined herein as transacting business from remote locations via electronic connections, is an integral part of the modern business landscape. E-commerce transaction processing includes every step involved in the process of buying a product or service online, including checking for inventory and discounts, confirming the order, fulfilling the order and, finally, processing the payment. The transaction is processed over data and/or voice communications networks using any of a variety of electronic and telecommunication technologies. Such networks include, for example, public or private networks, such as the Internet, the Public Switched Telephone Network (“PSTN”) and leased-lines, using wired, wireless or satellite technologies, or any combination of the above.

Conventionally, and as in the traditional “brick and mortar” model, before conducting online credit card e-commerce transactions, a merchant, or vendor, must establish a “merchant account.” A merchant account is a permanent payment processing account with an established credit card processing authority, such as First Data Merchant Services (FDMS). More particularly, the merchant applies and qualifies for a merchant account and, for an initial set-up fee, receives a unique merchant identification number (MID) that is used by the payment authorization and settlement entities. The MID account is typically established by FDMS through the services of a third party payment services organization, such as Cardservice International, Inc. (“CSI”). The payment gateway is the Internet equivalent of credit card verification terminals found in physical stores.

Typically, for each credit card purchase a customer makes at a merchant's online storefront, the merchant computer establishes an electronic connection to the third party payment gateway and uploads to it the customer's credit card number and transaction amount; i.e. the payment information. The connection is made using a standard telephone line direct modem connection, a dedicated, private leased line, or via the Internet, to name some of the more common communications means. The gateway, then (1) often via a high-speed, secure, dedicated, private leased line, transmits this payment information to a processing authority for authorization (or denial) of the transaction (i.e. by checking the availability of funds from the credit card issuing bank); and (2) notifies the merchant of such authorization for real-time completion of the online sale. Later, the merchant, through the processing authority, finally settles the transaction with the appropriate banks to effect the electronic transfer of the funds. The merchant typically pays a monthly merchant account fee plus a transaction fee for each transaction.

Many, if not most, online merchants do not have the high volume of online sales and associated payment processing needs to justify the costs of establishing for themselves and maintaining an e-commerce hosting and transaction processing infrastructure. Those merchants can out-source their e-commerce storefront development and hosting to Commerce Service Providers (“CSP's”) and their payment processing needs to an electronic gateway entity that communicates with the financial processing authorities. For example, FIG. 1a shows a conventional, online e-commerce payment architecture 10. In particular, a merchant online storefront, hosted by a merchant, CSP or ISP 14 is accessible to a customer's computer 12 via the Internet 16. This merchant, CSP or ISP is in remote communication with a gateway server 18, which houses, among other components, a customer and merchant database. The gateway, in turn, communicates with a credit card processing entity 20 which communicates with the various financial institutions 22, namely, the credit card issuing bank, the merchant bank and other banks, for authorization and settlement of transaction.

FIG. 1b shows the real-time process flow of an online credit card purchase transaction using the architecture shown in FIG. 1a. First, in step 40, the customer at his/her computer visits the merchant storefront web site, identifies the product or service of interest (“the commodity”), clicks on a “buy” (or equivalent) button, and enters customer identification information (e.g., name, shipping address) and credit card payment information. In step 42, the merchant storefront establishes a connection with the gateway entity, which retrieves the merchant identification data, such as the MID number, and transaction payment information. Next, in step 44, the gateway server establishes a connection with the credit card processing authority (e.g. FDMS) and uploads to it the MID number and transaction payment information (the credit card number and transaction amount). The financial processing authority then authorizes (or denies) the transaction with the card issuing bank in step 46, and notifies the gateway entity of the authorization/denial in step 48. It is then up to the gateway entity, in step 50, to notify the merchant and customer of the authorization so that the order can be fulfilled.

While this architecture works well for many online merchants, unfortunately, establishing, using and paying for a conventional merchant account does not make economic sense for a large segment of the vast worldwide population that currently conducts, or would like to be able to conduct, online credit card or debit card transactions. These individuals and very small businesses (hereinafter called “small-merchants”) include, for example, start-up “e-tailers” who would like to have their own web site storefronts with online transaction capabilities (e.g. “shopping carts”), and those that only casually or infrequently wish to sell items or services through online auction sites or online classified ads. These small merchants, or individuals, cannot justify, or afford to pay, the set fees and monthly fees for their merchant accounts. Moreover, new online retailers also often do not have the resources for creating the front and back end infrastructures for online stores and for accepting online credit or debit payments. They also usually cannot provide the customer service necessary to support such transaction capability (e.g. returns, chargebacks, etc.). While CSP's and ISP's address some of these concerns, the cost of payment processing remains a problem. Consequently, many small-merchants in these categories either choose not to offer their products and services online, or do, but cannot accept credit and debit cards as means of payment for their goods and services. Instead, they have been forced to offer far less convenient payment means to their customers, such as cash-only or paper checks, or more commonly, cashier's checks.

Nonetheless, online global communications networks, and particularly the Internet, have proven to be extremely efficient and inexpensive means for individuals and small-merchants to market their products and services and to offer for sale low-volume, low-cost items or services. For example, online auctions, online classified ads and other person-to-person web sites are inexpensive and successful venues for peddling single, or a small quantity of personal items. Unfortunately, small-merchant inability or resistance to establishing merchant accounts for accepting credit or debit cards has been a factor in limiting the proliferation of these and other small e-tail ventures. Further, e-commerce opportunities for small-merchants, both in wired and wireless environments (e.g. sales at garage sales, flea markets etc.), are expected to continue to grow at exponential rates.

These factors make it highly desirable to offer a solution that enables low-volume online merchants to offer their customers the convenience of credit or debit cards as a means of payment without setting up a permanent merchant account and without monthly or set-up fees.

It would be further desirable to have a system and method that would easily enable such small-merchants to transition into full merchant account status upon the growth of the merchant to the point where setting up such an account makes economic sense for the merchant.

In partial response to these needs, several solutions have recently been offered to the online marketplace, such as the Billpoint™ service offered on Ebay's web site, the Tradesafe.com™ escrow service and Paypal.com™. These services have their advantages for their niche markets, but are tailored to service either a single item auction type or escrow transactions or are not true e-commerce solutions, i.e. a mechanism specifically integrated with a product or service.

Thus, there is a definite need for a robust payment processing system that enables small-merchants to offer credit card or other established electronic payment vehicles for products and services they offer for sale online, whether it be via the Internet, an audio/telephonic communications medium or other online system, without the need for the merchant to have or use a standard permanent merchant account. This system should also enable simple conversion of such small-merchants to standard merchant accounts when the payment processing transaction volume justifies such conversion.

### SUMMARY OF THE INVENTION

The present invention, which addresses these needs, resides in a method and system for enabling small merchants to accept electronic payment from credit and debit cards, or the like, without the need for the merchant to have an established merchant account. The invention described below has a number of advantages, including: (a) it frees the small-merchant from having to establish a relatively costly permanent processing account in exchange for the ability to accept credit or debit cards as a payment means; (b) it eliminates conventional merchant account monthly and set-up fees; (c) it obviates the need for the merchant to establish in-house the infrastructure conventionally needed to conduct e-commerce; and (d) it provides such low-volume merchants with an easy transition to a traditional merchant account when the volume of sales increases to a point that justifies such transition.

In accordance with the present invention, a method of conducting e-commerce between an e-commerce merchant and a customer that pays with an established electronic payment vehicle over a communications network is disclosed. This method does not require a conventional merchant permanent payment processing account, also known as a “merchant account.” In this method, the merchant has an e-commerce site that resides on a host site of a merchant-hosting entity. The merchant-hosting entity, which does have a permanent payment processing account, contains a merchant database and is linked to an electronic payment processing authority via a payment gateway.

Accordingly, a method of conducting an e-commerce transaction over a communications network is disclosed. Specifically, a customer provides payment information to pay for selected goods or services offered by the merchant. This payment information is entered at the merchant's e-commerce site. This site, whether it be an Internet website, a wireless web page, a sound-based, telephone-accessed site or other site, is hosted by a merchant-hosting entity having a permanent payment processing account with a financial processing authority, such as First Data. Merchant identification information (MID) and the payment information is then submitted to the merchant-hosting entity. Once the MID is validated indicating that the merchant, in fact, has a valid account with the merchant-hosting entity, the payment information and payment processing account identification information is forwarded to a payment gateway entity (PGE).

The PGE then submits the payment information and merchant-hosting entity account identification information to the financial processing authority for payment authorization. IF authorized, authorization data is forwarded back to the merchant-hosting entity via the payment gateway. Finally, the merchant is notified that the payment was authorized and is free to fulfill the order for the goods or services. This advantageously enables the merchant to conduct an online financial transaction without using, or even possessing a permanent payment processing account.

Typically, the payment information provided by the customer includes account information, or number from at least one established electronic payment vehicle and a purchase amount. However, the purchase amount may not be provided by the customer. For example, in the typical situation whereat the customer on a computer selects the product or service for purchase, the storefront engine itself will supply the purchase amount. Further, the established electronic payment vehicle may be a credit card, debit card or any other accepted electronic payment vehicle that is associated with a financial authority, such as a bank.

Initially, the customer will typically select the goods or services for purchase at the merchant's e-commerce site. However, this is not a necessary step in the inventive method. In an alternative scenario, the customer may be present at the location of the merchant and may actually physically select a product or service for purchase. From that point, the customer or merchant can enter payment information, such as a credit card and transaction amount at the merchant's site which is accessible to the customer at a terminal that physically present at the point of purchase.

In the present method, in addition to submitting payment information, customer identification data may also be submitted to the merchant-hosting entity. This data may comprise, for example a customer name and delivery information, such as a shipping address or email address (for electronically delivery of products).

Typically, a single merchant-hosting entity is capable of hosting a plurality of different merchant sites. Further in the preferred embodiment, the customer is also notified of the authorization of the transaction, either electronically (e.g. via email) or by some other conventional means. Finally, as discussed in further detail below, the inventive method further includes the step of settling the transaction.

The inventive method offers several advantages to the small merchant. In particular, a merchant need not establish a standard, merchant account, which is relatively costly and that often takes several days for approval. Instead, by submitting to the gateway entity a simple online application, the merchant can in real-time be approved to accept payment from a customer using an established electronic payment vehicle and be ready to create a storefront that resides on the merchant-hosting entity's server. Every aspect of processing the transaction is handled remotely from the merchant.

The present invention also discloses an electronic payment processing system for processing transactions conducted between a merchant and a customer using an established payment vehicle, and without resort to a merchant permanent payment processing account. The system comprises a communications network, a merchant-hosting entity server that hosts the merchant storefront, an electronic payment gateway entity and an electronic payment processing authority. More particularly, the merchant-hosting entity server is connected to the network and is associated with a permanent merchant payment processing account or a merchant ID, and hosts the merchant storefront site whereat a customer may place an order, a merchant-hosting database containing a table for holding a merchant-id, customer-id, order information and payment information, and an API (application program interface) that supports online order transaction functionality.

The electronic payment gateway entity is connected to the network between the merchant host servers and the electronic payment processing authority and stores merchant-id and routes all payment critical information to all entities in the system. The electronic payment processing authority communicates with the payment gateway to authorize (or deny) the customer-initiated transaction, due to credit limit or credit risk factors identified by the customer's card issuing financial institution.

The present invention further includes a method for automatically enabling a merchant to accept orders for goods or services electronically at a merchant site, without the merchant using a permanent payment processing account. The site is hosted by a merchant-hosting entity that has a permanent payment processing account. The merchant site is also linked to an electronic payment processing authority via a payment gateway. The method includes the merchant electronically submitting a merchant application from a merchant-hosting entity site to a payment gateway entity, the merchant receiving an automatic approval notification (email), the merchant-hosting authority receiving merchant approval notification from the payment gateway entity, and the payment gateway entity activating the merchant account and assigning a user_id to the merchant account. This method automates and simplifies the process of obtaining, what is to the small merchant, a merchant account in real time.

Finally, the present invention discloses a method for settling transactions that were conducted using the architecture of the present invention. The funds for the transaction that come from the credit card issuing bank are initially deposited by the payment processing authority to an acquiring bank and are to be finally deposited in the appropriate payee banks. To accomplish this, the method includes the payment gateway entity matching authority-settled transactions for each merchant-hosting entity to the specific merchant transaction, and the payment gateway entity parsing the funds deposited in the acquiring bank to the appropriate payee banks.

In a more particular aspect of the transaction settlement architecture of the present invention, the parsing of funds step includes the steps directing the acquiring bank to fund and funding the payment gateway bank the transaction amount and the transaction fee; the payment gateway bank funding the payment authorization entity a processing fee for the transaction; the payment gateway bank funding the merchant-hosting entity bank an agreed upon residual fee and the payment gateway bank funding the amount of the transaction.

Other features and advantages of the present invention should become more apparent from the following description of the preferred embodiments, taken in conjunction with the accompanying drawings, which illustrate, by way of example, the principles of the invention.

### BRIEF DESCRIPTION OF THE DRAWINGS

FIG. 1a is a block diagram illustrating a conventional electronic commerce transaction processing architecture;

FIG. 1b is a flow diagram showing the basic steps used in conducting a transaction using the architecture shown in FIG. 1a;

FIG. 2 is a block diagram illustrating one preferred embodiment of the merchant setup module of the present invention;

FIG. 3 is diagram showing the basic architecture for the purchase and credit authorization process implemented by the present invention;

FIG. 4 is a flow chart that describes the preferred payment processing and authorization steps used in the architecture shown in FIG. 3; and

FIG. 5 is a diagram showing the preferred financial settlement architecture implemented by the present invention.

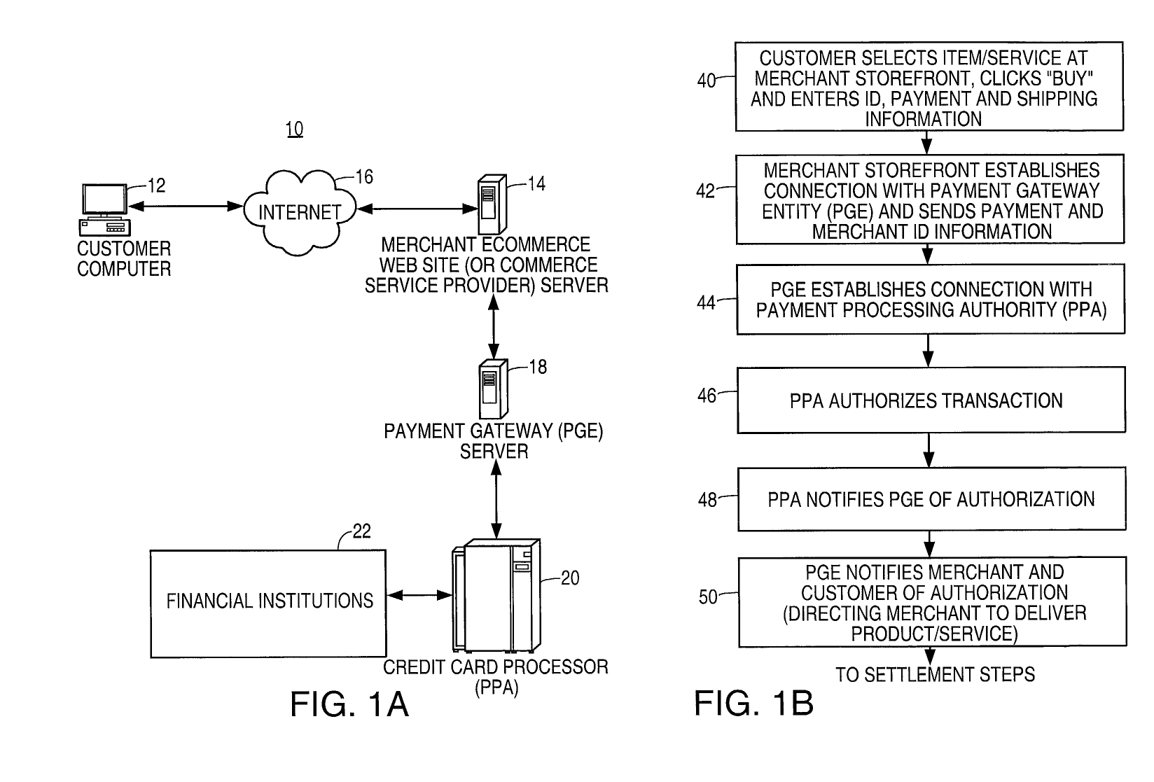

### DETAILED DESCRIPTION OF THE PREFERRED EMBODIMENTS

The invention summarized above and defined by the enumerated claims may be better understood by referring to the following detailed description, which should be read in conjunction with the accompanying drawings. This detailed description of particular preferred embodiments, set out below to enable one to build and use particular implementations of the invention, is not intended to limit the enumerated claims, but to serve as particular examples thereof The particular examples set out below are the preferred specific implementations of three aspects, or modules, of the present invention, namely: (1) the novel process for automatically setting-up small-merchants to conduct online transactions without a permanent merchant account, or, “the set-up module; (2) the novel process for accepting online orders and authorizing payment, or, “the order and payment module”; and (3) “the transaction settlement module.” The description also sets out preferred implementations for automatically converting such small-merchants to a conventional online merchant payment processing account.

1. The Small-Merchant Set-Up Module

The present invention enables small-merchants to sell products and/or services online in a secure environment without incurring the expense of costly hardware infrastructure and without establishing a permanent merchant payment processing account. It should be understood that the term “online” is used herein in the broad sense of term, namely, an environment wherein one communication device or entity can remotely communicate with another, and is not limited to a computer being connected and communicating with another via a public or private computer network, such as the Internet or a LAN. For example, for purposes of this invention, a person who calls an automated telephonic menuing and ordering service, such as the Moviefone™ or Telecharge™ systems, or via wireless communication systems, is considered “online.” However, online commerce via an Internet storefront is the preferred embodiment for implementing the present invention. Thus, this implementation will be discussed hereinafter.

Structurally, in the preferred embodiment, small-merchant storefronts are hosted by larger service providers, such as Internet Service Providers (“ISP's”) and Commerce Service Providers (“CSP's”), hereinafter collectively called “merchant-hosting entities” (“MHE's”). MHE's, in turn, partner with a secure payment gateway entity (“PGE”) that routes all payment transactions to, and receives all authorization and settlement payment information from, a payment processing authority (“PPA”). Before hosting small-merchants, MHE's must apply for and obtain a permanent merchant account configured to operate with the PGE. In some instances, the MHE and PGE can be the same entity. Upon MHE approval, the MHE receives a gateway account number and password, and the software tools, called “wrappers,” for integrating the software required to allow small-merchants' storefronts to accept credit cards as a form of payment on its web site. The PGE then certifies that the integration is complete and the MHE is ready to activate a link to their online small-merchant application and begin offering the small-merchant service from their web site.

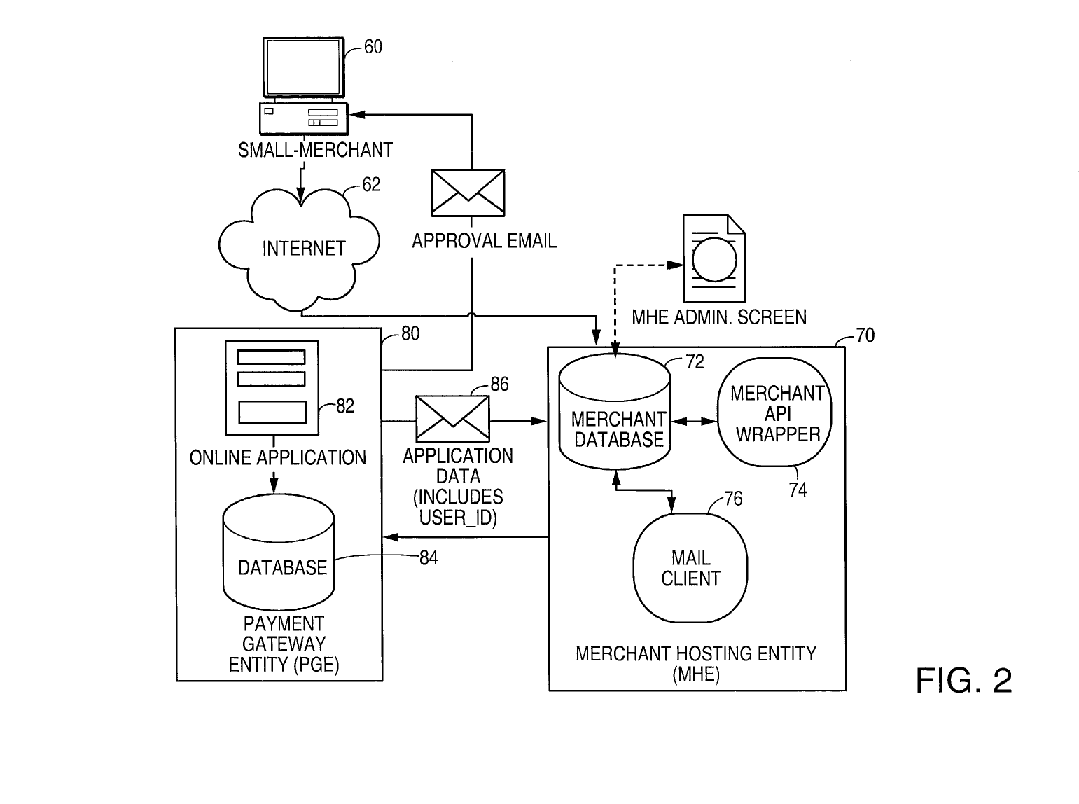

FIG. 2 illustrates the preferred process by which an individual or small business establishes itself as an online merchant. In particular, the small-merchant, via its computer 60, accesses the Internet 62, visits the MHE's web site and links to an online merchant application 82, which is actually (but transparently) hosted by the PGE server. The small-merchant completes a series of simple online application forms 82, agrees to the terms of the merchant agreement and clicks a “submit application” (or equivalent) button to submit the merchant application data to the PGE 80. The PGE approves or denies the application. In the preferred embodiment, for the typical application, there is no human decision-making. Rather, the approval/denial is completely automated. Then, upon approval, the PGE generates a unique user_id to be associated with the small-merchant, stores the data and user_id in a PGE database 84, and passes application data to the MHE 70, indicating approval of the merchant account application. In the embodiment shown, the application data is contained in an email notification 86. In this preferred embodiment, the MHE contains a small-merchant mail client, such as a MAPI (“messaging application programming interface”) client (a system that enables different e-mail applications to work together to distribute components of an email) 76, that parses the email and adds the user_id to be stored in an MHE small-merchant database 72. The MHE is also sent an email containing the information necessary for the MHE to activate the merchant for processing payment transactions through the PGE. Once the MHE activates the merchant through the email client, the small-merchant receives notification of such approval and may begin accepting orders from customers. It will be understood by those skilled in the art that the application data need not be sent to the MHE and via an email. Any electronic means for transmitting the data may be used.

2. The Order and Payment Module

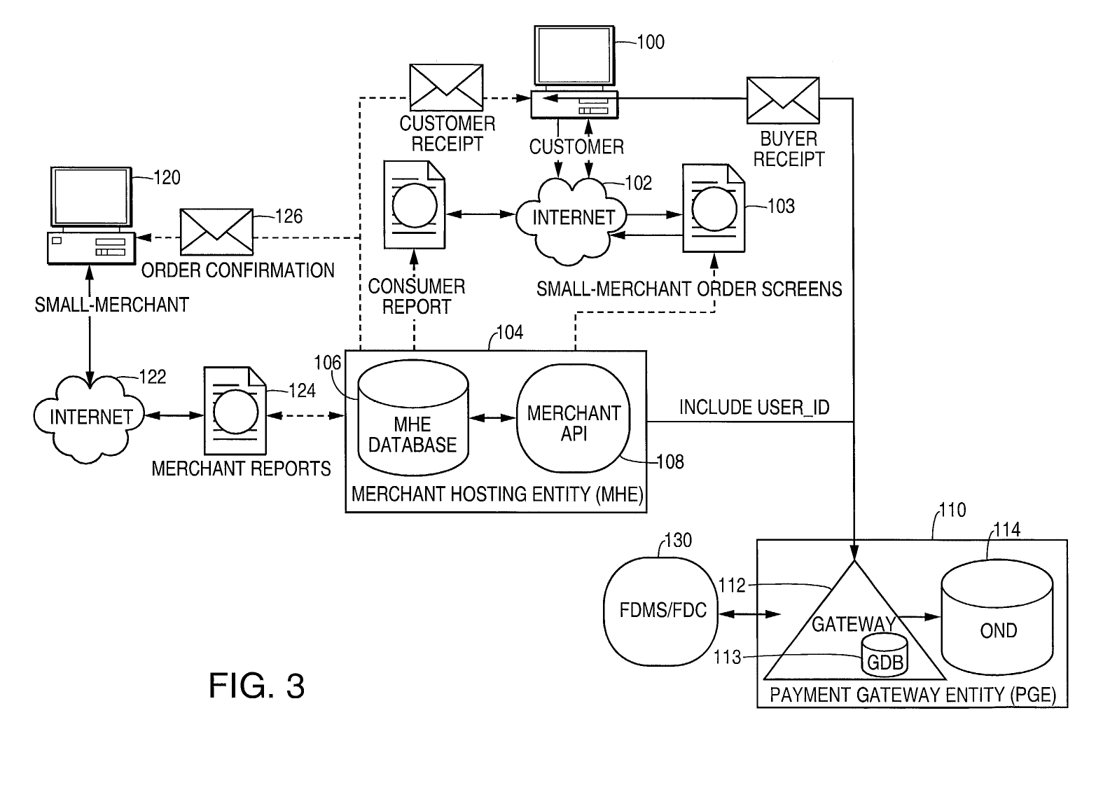

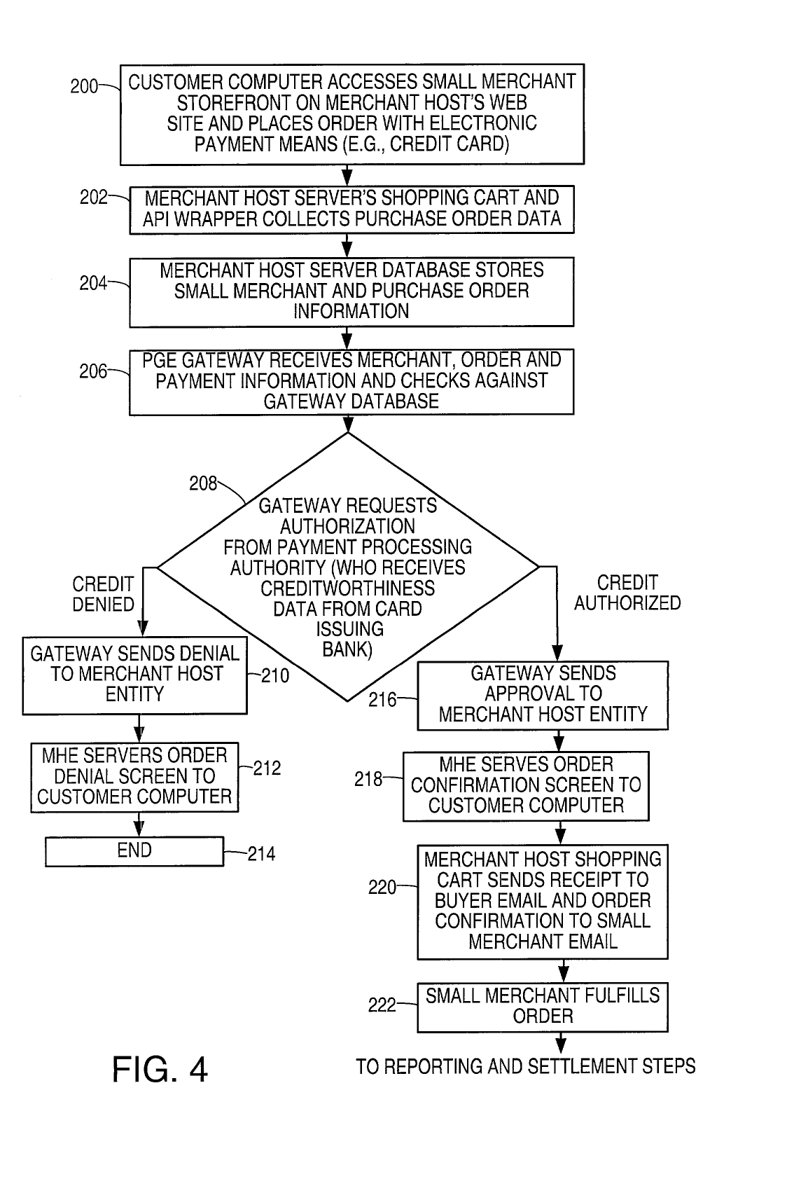

FIG. 3 shows the preferred basic architecture for implementing the purchase and credit authorization process of the present invention and FIG. 4 shows the flow of a transaction using this architecture. Referring to FIG. 3, the customer computer 100, through the Internet 102, accesses the small-merchant's online storefront and reaches the small-merchant's order screens 103. As seen, these screens are hosted and served up by the Merchant-hosting Entity (MHE) 104, which contains the MHE database 106 and a Merchant API 108. The customer identifies and selects one or more products and/or services s/he wishes to purchase and places an online order at the small-merchant's storefront order screens 103. This data includes customer_id information, payment and shipping information and other necessary information. In the preferred embodiment, the payment and other required data are forwarded to the PGE to enable the payment to be processed. Selected data may also be captured by the MHE for small-merchant and customer support purposes. The API 108 is code that contains all the functionality needed to process secure transactions at the MHE level and ensures that the small-merchant has been authorized, as was described in relation to FIG. 2.

The MHE 104 is connected to a payment gateway entity (PGE) 100, which includes a gateway 112 and an operation network database 114. The gateway and network databases store all data relating to both MHE data and every valid merchant user_id, representing every small-merchant that is authorized to process transactions via MHE's. The user_id and credit card data is forwarded to the PGE by the MHE. The PGE uses the user_id information to confirm that the small-merchant is an approved and valid merchant. The credit card data (transaction amount and credit card number) is parsed to a payment processing authority 130 which authorizes (or denies) the transaction.

Turning now to FIG. 4, which shows a preferred process flow of a single e-commerce transaction using the architecture of the present invention, in step 200, the customer accesses the small-merchant storefront residing on the MHE's web site and server and places an order using an electronic payment means, such as a credit card. In step 202, the MHE's shopping cart and API collect the order data that includes the item, the price, the customer name and shipping information and credit card data. In this embodiment, in step 204, the MHE server stores both the order and user_id data. In step 206, the MHE sends the merchant's user-id, the MHE's own MID (the merchant account number), and item and payment information to the PGE, which validates that both the MHE and small-merchant are approved entities. Then, in step 208, the PGE queries the PPA for authorization of the transaction. The “authorization” step verifies that the credit card number is valid and that there are sufficient funds to fund the transaction (i.e. that the credit is good). If the PPA (by communicating with the card issuing bank) denies the transaction and returns a denial to the PGE, in step 210 the PGE sends a denial response to the MHE. The MHE, in step 212, then serves an order denial screen to the customer computer, and, in step 214, the transaction is thereby terminated.

If, however, the PPA authorizes the credit transaction, the PGE, in step 216, sends an approval signal to the MHE, which, in turn, in step 218, serves an order confirmation screen to the customer. In the preferred embodiment, in step 220, the MHE shopping cart automatically sends (1) an email receipt to the customer's email address and (2) an order confirmation email to small-merchant's email indicating payment authorization. In this case, the merchant, in step 222, is now able to fulfill the order. As a backup, the PGE may also send an email receipt to the customer. Then, in step 224, the transactions are reported out. Settlement occurs at some later stage, to be discussed below.

Referring momentarily back to FIG. 3, the small-merchant at 120 may access from the MHE database 106 merchant order reports 124 via the Internet 122. From these online reports, the small-merchant may view the order and mark it as shipped, thereby triggering a “capture.” Alternatively, the merchant may issue a credit to the customer (such as a discount). These small-merchant actions are captured in the MHE database and passed to the PGE. The customer 100 may also access reports from the MHE database 106 via the Internet 102 in order to view the status of its order.

3. The Transaction Settlement Module

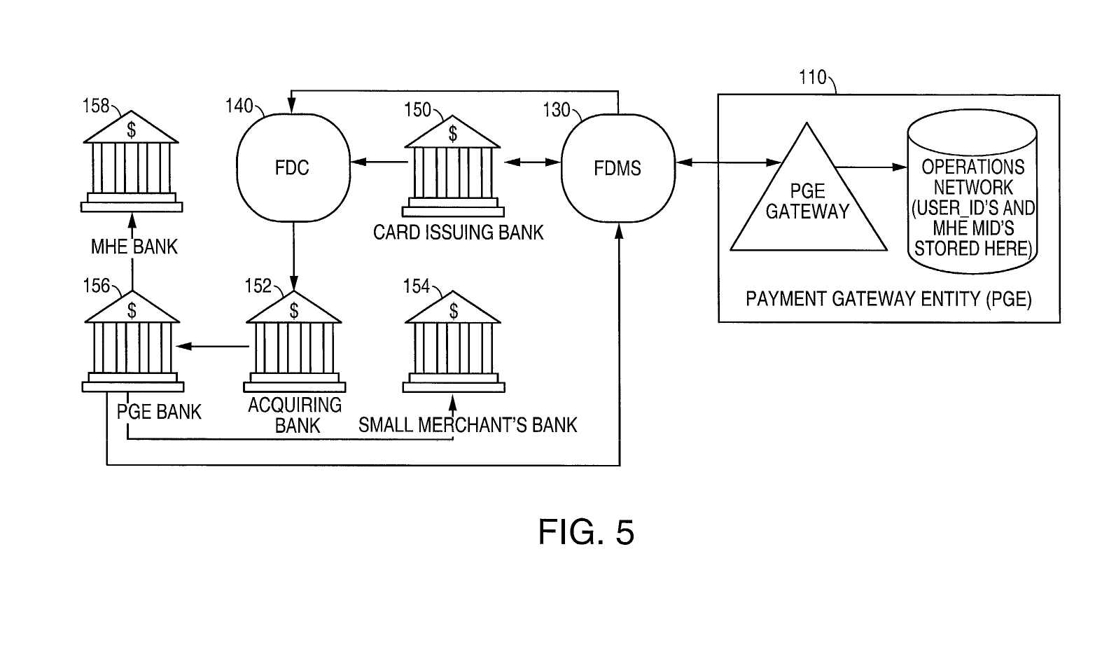

Turning now to FIG. 5, at some time after authorization, the settlement process is initiated. Settlement is herein defined as the electronic distribution of the correct amount of funds corresponding to each transaction to the appropriate entities. In particular, the payment settlement authority 140 forwards the appropriate amount of funds from the customer's credit card issuing bank 150 to an acquiring bank 152. Recall that all payment processing occurs at the MHE level. Thus, transaction settlement must be and is handled by the PGE. In particular, the PGE has the complicated tasks of (1) matching approved transactions for each MHE to the specific small-merchant which initiated the transaction; and (2) parsing the funds deposited in the acquiring bank to the appropriate payee banks. The PGE is able to perform these tasks because it stores all of the data necessary for settlement, including the small-merchant data and transaction data. Thus, the acquiring bank 152 funds the PGE bank, which, under direction of the PGE, funds the small-merchant bank 154 for the amount of the transaction, minus any fees due to the PGE. Finally, the PGE bank pays (1) the payment authorization entity (FDMS) 130 the appropriate processing fee for the transaction; and (2) the MHE bank 158 any agreed upon residual fees due to it for hosting the transaction.

Having thus described exemplary embodiments of the invention, it will be apparent that further alterations, modifications, and improvements will also occur to those skilled in the art. Further, it will be apparent that the present methods and systems are not limited to use with online computer systems. For example, the payment processing architecture described and claimed herein can be applied to the sale of goods and service over a telephone system. Such alterations, modifications, and improvements, though not expressly described or mentioned above, are nonetheless intended and implied to be within the spirit and scope of the invention.

Accordingly, the foregoing discussion is intended to be illustrative only; the invention is limited and defined only by the various following claims and equivalents thereto.

We claim:

1. A method of conducting an e-commerce transaction over a communications network, comprising:
(a) a customer providing payment information to pay for selected goods or services offered by a merchant;
(b) entering the payment information on an e-commerce site associated with the merchant and that is hosted by a merchant-hosting entity having a permanent payment processing account, and associated account identification information, with a financial processing authority;
(c) submitting merchant identification information and the payment information to the merchant-hosting entity;
(d) validating the merchant identification information;
(e) upon validation, forwarding the payment information and payment processing account identification information to a payment gateway entity;
(f) the payment gateway entity submitting the payment information and account identification information to the financial processing authority for payment authorization;
(g) upon authorization, forwarding authorization data to the merchant-hosting entity via the payment gateway; and
(h) notifying the merchant of the payment authorization.

2. The method of claim 1, wherein a permanent payment processing account associated with the merchant is not used in connection with the transaction.

3. The method of claim 1, wherein the payment information includes account information from at least one established electronic payment vehicle and a purchase amount.

4. The method of claim 3, wherein the at least one established electronic payment vehicle is one of a credit card, a debit card, purchase card, virtual check and smart card.

5. The method of claim 1, further including the step of the customer selecting the goods or services for purchase at the merchant's e-commerce site prior to step (a).

6. The method of step 1, wherein step (b) further includes submitting customer identification data to the merchant-hosting entity.

7. The method of step 6, wherein the customer identification data comprises a customer name and delivery information.

8. The method of claim 1, wherein the merchant-hosting entity is capable of hosting a plurality of different merchant sites.

9. The method of claim 1, wherein the merchant and the merchant-hosting entity are separate entities.

10. The method of claim 1, wherein the merchant's e-commerce site is a website.

11. The method of claim 1, wherein the merchant's e-commerce site is accessible telephonically.

12. The method of claim 1, further including the step of notifying the customer of the authorization of the transaction.

13. The method of claim 1, further including the step of settling the transaction.

14. An e-commerce transaction system for processing payment for goods or services offered by a merchant and selected for purchase by a customer using an established electronic payment vehicle, and without resort to a permanent payment processing account associated with the merchant, the system comprising:
(a) a communications network;
(b) a merchant-hosting entity computer system connected to the network and associated with a permanent merchant payment processing account, the merchant-hosting entity computer system including
a server that hosts a merchant-hosting entity site and a merchant e-commerce site whereat payment information from the established electronic payment vehicle may be entered to pay for the selected goods or services,
a database containing a table for storing merchant identification data, customer identification data, and the payment information, and
an application program interface wrapper that integrates the merchant's e-commerce site with the merchant-hosting entity site;
(c) an electronic payment gateway computer system connected to the network and in communication with the merchant-hosting entity computer system, that stores the merchant identification data; and
(d) an electronic payment processing authority computer system in communication with the payment gateway computer system that authorizes the customer payment for the selected goods or services.

15. The e-commerce transaction system of claim 14, wherein the established electronic payment vehicle is a credit card.

16. The e-commerce transaction system of claim 14, wherein the merchant-hosting entity server host a plurality of merchant sites.

17. The e-commerce transaction system of claim 14, wherein the merchant's e-commerce site is a website.

18. The e-commerce transaction system of claim 14, wherein the merchant's e-commerce site is accessible telephonically.

19. A method of electronically enabling a merchant to accept orders for electronic processing at a site without using a merchant permanent payment processing account, the site being hosted by a merchant-hosting entity that has a permanent payment processing account and that is linked to an electronic payment processing authority via a payment gateway, the method including:
(a) the merchant electronically accessing a merchant account application at a site;
(b) the merchant electronically submitting the merchant application to a payment gateway entity;
(c) the merchant receiving a merchant account approval notification;
(d) the merchant-hosting entity receiving merchant account approval notification from the payment gateway entity; and
(e) the payment gateway entity activating the merchant account.

20. The method of claim 19, wherein the merchant application is accessible at the site of the merchant-hosting entity site.

21. The method of claim 19, wherein the approval notification received by the merchant is sent via e-mail.

22. A method of electronically settling online payment transactions conducted between e-commerce merchants customers that pay with established electronic payment vehicles over a communications network and without resort to merchant-level permanent payment processing accounts, wherein each merchant has an e-commerce site accessible to customers that is hosted by a merchant-hosting entity and a unique merchant identification code associated with, and stored in a merchant database of, the merchant-hosting entity, the merchant-hosting entity further having a permanent payment processing account and being linked, via a payment gateway entity, to an electronic payment processing authority for authorization of merchant transactions, wherein funds for the transaction that are to be finally deposited in the appropriate payee banks are initially deposited by the payment processing authority into an acquiring bank, the method including:
(a) the payment gateway entity matching each transaction authorized by the payment processing authority on behalf of the merchant-hosting entity with the appropriate merchant; and
(b) the payment gateway entity parsing funds deposited in the acquiring bank to the appropriate payee banks.

23. The method of claim 22, wherein the parsing step includes the steps of:
(a) the payment gateway entity directing the acquiring bank to fund and funding the payment gateway bank the transaction amount;
(b) the payment gateway bank funding the merchant bank the amount of the transaction less a transaction fee;
(c) from the transaction fee, the payment gateway bank funding the payment authorization entity a processing fee; and
(d) the payment gateway bank funding the merchant-hosting entity bank an agreed upon residual fee.
